(19) United States
(12) Patent Application Publication
(10) Pub. No.: US 2008/0220701 A1
(43) Pub. Date: Sep. 11, 2008

(54) Polishing Pad and Method for Making the Same

(76) Inventors: Chung-Ching Feng, Kaohsiung (TW); Chen-Hsiang Chao, Kaohsiung (TW); I-Peng Yao, Kaohsiung (TW); Yung-Chang Hung, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/123,558

(22) Filed: May 20, 2008

Related U.S. Application Data
(63) Continuation-in-part of application No. 11/323,651, filed on Dec. 30, 2005.

(51) Int. Cl. B32B 33/00; B05D 5/00; B24D 13/00; B24D 11/00; B24D 3/32; B24D 3/28; B24D 18/00

(52) U.S. Cl. 451/527; 427/243; 427/245; 428/86

(57) ABSTRACT

A method for making a polishing pad includes providing a non-woven fabric made of a plurality of fibers. The non-woven fabric is submerged with a polymer resin solution. The polymer resin submerged in non-woven fabric is cured to form a porous polymer having an outer face adapted for polishing a workpiece. The outer face of the porous polymer is finished to form a polishing pad with a plurality of naps on the outer face. The plurality of naps on the outer face have a density ranging from 1.0 to 2.0 g/cm3, and the plurality of naps on the outer face have a length ranging from 50 to 600 μm.

### CROSS REFERENCE TO RELATED APPLICATION

This is a continuation-in-part application of U.S. patent application Ser. No. 11/323,651 filed Dec. 30, 2005.

### BACKGROUND OF INVENTION

1. Field of Invention

The present invention relates to a polishing pad and, more particularly, to a polishing pad for use in a chemical mechanical polishing process and the present invention also relates to a method for making the polishing pad.

2. Related Prior Art

Chemical mechanical polishing (“CMP”) processes are used in semi-conductors and liquid crystal display industries to make the surfaces of semi-conductor substrates and glass substrates planar.

U.S. Pat. No. 6,860,802 entitled “Polishing pads for chemical mechanical planarization” discloses polishing pads made by a method including pouring a thermosetting mixture into a cylindrical mold with grooves, curing the thermosetting mixture to become a block, and cutting the block into films. Then, each of the films is polished and becomes a polishing pad. However, as the density of the thermosetting plastic varies at different points in the mold, and as the temperature varies at different points in the mold, the resultant polishing pads include holes that are different from one another in size and unevenly positioned. After the polishing and cutting process, the difference in the sizes of the holes gets more obvious. Moreover, the holes are often not in communication with one another so that slurry cannot flow smoothly and so that polishing particles contained in the slurry cannot be distributed effectively. Furthermore, debris cannot be expelled from the polishing pad so that the debris scratches a workpiece that is being polished. In addition, as the polishing pads are made in batches, the polishing pads vary considerably from batch to batch. Thus, it is very difficult to control the polishing effects using the polishing pads made in this conventional process.

The present invention is therefore intended to obviate or at least alleviate the problems encountered in the prior art.

### SUMMARY OF INVENTION

According to a first aspect of the present invention, a method for making a polishing pad includes providing a non-woven fabric made of a plurality of fibers. The non-woven fabric is submerged with a polymer resin solution. The polymer resin submerged in the non-woven fabric is cured to form a porous polymer having an outer face adapted for polishing a workpiece, with the plurality of fibers embedded in the porous polymer. The outer face of the porous polymer is finished or fluffed to form a plurality of naps on the outer face, with the naps on the outer face having a density ranging from 1.0 to 2.0 g/cm3, and with the naps on the outer face having a length ranging from 50 to 600 μm.

Preferably, finishing the outer face includes finishing the outer face to expose end portions of some of the plurality of fibers of the non-woven fabric outside the outer face to form the naps.

Preferably, finishing the outer face includes finishing the outer face by at least one of lapping, kneading, electrostatic treatment, bonding, and coating.

Preferably, finishing the outer face includes finishing the outer face to form the plurality of naps having a volume ratio in a range of 0.35-0.5□ to the porous polymer.

Preferably, curing the polymer resin includes curing the polymer resin submerged in the non-woven fabric to form the porous polymer having a solid content ranging from 4 to 20% by weight.

Preferably, curing the polymer resin includes curing the polymer resin submerged in the non-woven fabric to form the porous polymer having a plurality of continuous holes bonded to the non-woven fabric, with the holes having a diameter between 0.1 μm and 500 μm.

According to a second aspect of the present invention, a polishing pad includes a porous polymer with an outer face adapted for polishing a workpiece and a non-woven fabric made of fibers including a plurality of embedded fibers and a plurality of partially exposed fibers. The embedded fibers are completely embedded in the porous polymer. Each partially exposed fiber includes an embedded portion embedded in the porous polymer and an exposed end portion exposed outside the outer face. The exposed end portions of the partially exposed fibers have a density ranging from 1.0 to 2.0 g/cm3, and the exposed end portions of the partially exposed fibers have a length ranging from 50 to 600 μm.

Preferably, the porous polymer has a solid content ranging from 4 to 20% by weight.

Preferably, the volume ratio of the exposed end portions of the partially exposed fibers to the porous polymer is in a range of 0.35-0.5 □.

Preferably, the porous polymer contains at least one material selected from a group consisting of polyamide resin, polycarbonate resin, epoxy resin, phenolic resin, polyurethane resin, divinylbenzene resin, acrylic acid resin, and polyurethane resin.

Preferably, the porous polymer has a plurality of continuous holes bonded to the non-woven fabric, with the continuous holes having a diameter between 0.1 μm and 500 μm.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is a flowchart of a method for making a polishing pad according to the preferred embodiment of the present invention.

FIG. 2 is a cross-sectional view of a semi-product of the polishing pad according to the preferred embodiment of the present invention.

FIG. 3 is a cross-sectional view of a final product of the polishing pad according to the preferred embodiment of the present invention.

### DETAILED DESCRIPTION OF PREFERRED EMBODIMENT

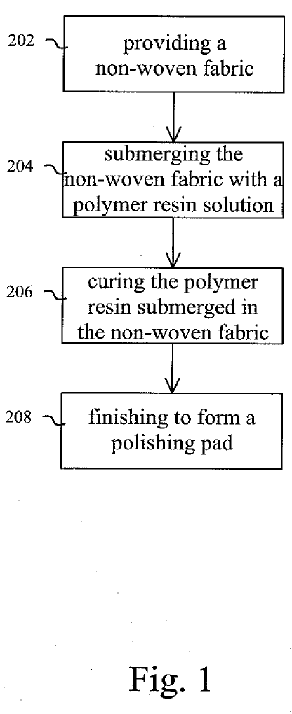

A method for making a polishing pad according to the preferred teachings of the present invention will be described with reference to FIG. 1.

Firstly, a non-woven fabric is provided (FIG. 1, part 202). The non-woven fabric is made of a plurality of fibers by stitching. The fibers may be single-component fibers or composite fibers. The single-component fibers may be made of polyamide resin, polyester resin, poly-acrylic resin or polyacrylonitrile resin. The composite fibers may be made of any combination of polyamide resin, polyester resin, poly-acrylic resin or polyacrylonitrile resin. In the preferred embodiment, the non-woven fabric is made of composite fibers of 3 denier by needle punch. The composite fibers include 70% of nylon and 30% of polyethylene terephthalate (“PET”). The thickness of the non-woven fabric is 2.25 mm, the density is 0.22 g/cm³, and the weight is 496 g/m².

Then, the non-woven fabric is submerged with a polymer resin solution (FIG. 1, part 204). Thus, the polymer resin solution covers the fibers of the non-woven fabric and enters gaps between the fibers of the non-woven fabric. The polymer contains at least one material selected from a group consisting of polyamide resin, polycarbonate resin, epoxy resin, phenolic resin, polyurethane resin, divinylbenzene resin, acrylic acid resin, and polyurethane resin. In the preferred embodiment, the polymer resin solution includes 50% of polyurethane resin, 49% of dimethylformamide (“DMF”), and 1% of surfactant.

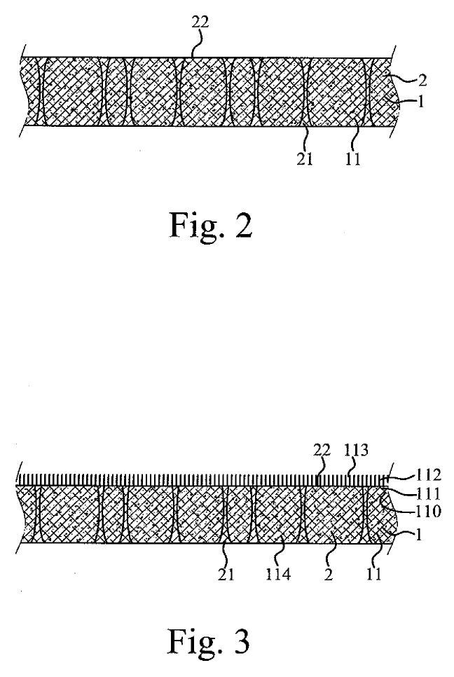

Then, the polymer resin submerged in non-woven fabric is cured in a curing agent to form a semi-product of the polishing pad (FIG. 1, part 206). The curing agent includes 75% of water and 25% of dimethylformamide (“DMF”). FIG. 2 shows a cross-sectional view of the semi-product of the polishing pad. The semi-product includes the non-woven fabric 1 made of the fibers 11 and a porous polymer 2 having a plurality of continuous holes 21 bonded to the non-woven fabric 1. The fibers 11 of the non-woven fabric 1 are embedded in the porous polymer 2. Further, the porous polymer 2 defines an outer face 22 adapted for polishing a workpiece such as a semi-conductor substrate or a glass substrate.

Finally, the outer face 22 of the porous polymer 2 is finished to form a final product of the polishing pad with a thickness of about 1.28 mm (FIG. 1, part 208). FIG. 3 shows a cross-sectional view of the final product of the polishing pad. The outer face 22 is finished to expose end portions 112 of some of the fibers 11 of the non-woven fabric 1 outside the outer face 22 such that the final product includes the porous polymer 2 having the plurality of continuous holes 21 and the non-woven fabric 1 including a plurality of embedded fibers 114 and a plurality of partially exposed fibers 110. The embedded fibers 114 are completely embedded in the porous polymer 2. Each partially exposed fiber 110 includes an embedded portion 111 embedded in the porous polymer 2 and an exposed end portion 112 exposed outside the outer face 22. The exposed end portions 112 of the partially exposed fibers 110 form a plurality of naps on the outer face 22 with a plurality of gaps 113 existing between the naps. It should be noted that the cross-sectional views of FIGS. 2 and 3 are drawn for the purpose of illustration but not drawn in proportion.

The polishing pad of the present invention has the continuous holes 21 in the porous polymer 2 and on the outer face 22. The continuous holes 21 of the polishing pad have an even size so that the flow of the slurry between a workpiece (such as a wafer) and that the polishing pad is smooth and polishing particles contained in the slurry can be distributed effectively. Specifically, if the diameters of the holes are too large, polishing particles in the slurry will gather in the holes while polishing the workpiece. On the other hand, if the diameters of the holes are too small, the polishing particles in the slurry will not pass through the holes. It is preferred that the diameters of the holes are between 0.1 μm and 500 μm.

Furthermore, the polishing pad of the present invention has the naps 112 on the outer face 22 with the gaps 113 existing between the naps 112 (see FIG. 3). The naps 112 act as a brush to sweep slurry into and out of the workpiece surface during polishing, and the gaps 113 between the naps 112 can retain a portion of slurry to provide a more uniform distribution of liquid pressure for the slurry between the workpiece and the polishing pad. This not only enhances the polishing effect but reduces the consumed amount of slurry. A further advantage of the naps 112 is that the slurry in the holes 21 of the porous polymer 2 can be moved out of the porous polymer 2 to the outer face 22 through capillary action provided by the naps 112, preventing damage to the polishing pad.

For above satisfactory polishing effect, the naps 112 on the outer face 22 have been found to have a length ranging from 50 to 600 μm, more preferably, a length of about 150 μm. Furthermore, in order to have an above satisfactory polishing function, the density of the naps 112 on the outer face 22 is preferably from 1.0 to 2.0 g/cm3, and the volume ratio of the exposed end portions 112 of the partially exposed fibers 110 to the porous polymer 2 is preferably in a range of 0.35-0.5□. Further, the solid content of the porous polymer 2 is preferably from 4 to 20% by weight to allow easy fluffing of the outer face 22.

Furthermore, the properties, content, particle content and modulus of the polymer can be adjusted to control the hardness and compressibility of the polishing pad. The rigidity of the polishing pad can be adjusted through adjusting the rigidity and hydrophilicity of the fibers. The rigidity and hydrophilicity of the fibers can be adjusted through adjusting the content of the fibers. For example, polyethylene terephthalate (“PET”) is hydrophobic while nylon is hydrophilous. In addition, the polishing pad can be made in a roll-to-roll manner according to the method of the present invention, i.e., it can be made in a roll suitable for mass production. Thus, with the method of the present invention, differences between batches of polishing pads made according to conventional methods are eliminated.

The method for making a polishing pad according to the preferred teachings of the present invention can further includes a step of washing to wash impurities, residual DMF and residual surfactant from the non-woven fabric and a step of drying to dry the non-woven fabric and the porous polymer after curing the polymer resin submerged in non-woven fabric. The steps of washing and drying can be but not limited to conventional washing and drying processes. Preferably, the polymer resin is washed in hot water at 80 degrees centigrade and dried at 140 degrees centigrade.

The present invention has been described through the detailed description of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A method for making a polishing pad, the method comprising:
providing a non-woven fabric made of a plurality of fibers;
submerging the non-woven fabric with a polymer resin solution;
curing the polymer resin submerged in the non-woven fabric to form a porous polymer having an outer face adapted for polishing a workpiece, with the plurality of fibers embedded in the porous polymer; and
finishing the outer face to form a plurality of naps on the outer face, with the plurality of naps on the outer face having a density ranging from 1.0 to 2.0 g/cm3, and with the plurality of naps on the outer face having a length ranging from 50 to 600 μm.

2. The method according to claim 1 wherein finishing the outer face includes finishing the outer face to expose end portions of some of the plurality of fibers of the non-woven fabric outside the outer face to form the plurality of naps on the outer face.

3. The method according to claim 1, wherein finishing the outer face includes finishing the outer face to form the plurality of naps having a volume ratio in a range of 0.35-0.5□ to the porous polymer.

4. The method according to claim 2, wherein finishing the outer face includes finishing the outer face by at least one of lapping, kneading, electrostatic treatment, bonding, and coating.

5. The method according to claim 2, wherein curing the polymer resin includes curing the polymer resin submerged in the non-woven fabric to form the porous polymer having a plurality of continuous holes bonded to the non-woven fabric, with the holes having a diameter between 0.1 μm and 500 μm.

6. The method according to claim 2, wherein curing the polymer resin includes curing the polymer resin submerged in the non-woven fabric to form the porous polymer having a solid content ranging from 4 to 20% by weight

7. A polishing pad comprising:
a porous polymer with an outer face adapted for polishing a workpiece; and
a non-woven fabric made of fibers including a plurality of embedded fibers and a plurality of partially exposed fibers, with the plurality of embedded fibers being completely embedded in the porous polymer, with each of the plurality of partially exposed fibers including an embedded portion embedded in the porous polymer and an exposed end portion exposed outside the outer face, with the exposed end portions of the plurality of partially exposed fibers having a density ranging from 1.0 to 2.0 g/cm3, and with the exposed end portions of the plurality of partially exposed fibers having a length ranging from 50 to 600 μm.

8. The polishing pad according to claim 7, with the porous polymer having a solid content ranging from 4 to 20% by weight.

9. The polishing pad according to claim 7, with the volume ratio of the exposed end portions of the plurality of partially exposed fibers to the porous polymer being in a range of 0.35-0.5□.

10. The polishing pad according to claim 7, with the porous polymer containing at least one material selected from a group consisting of polyamide resin, polycarbonate resin, epoxy resin, phenolic resin, polyurethane resin, divinylbenzene resin, acrylic acid resin, and polyurethane resin.

11. The polishing pad according to claim 7, with the porous polymer having a plurality of continuous holes bonded to the non-woven fabric, and with the holes having a diameter between 0.1 μm and 500 μm.

12. The polishing pad according to claim 7, with the exposed end portions of the plurality of partially exposed fibers having a length of about 150 μm.
